(19) United States
(12) Patent Application Publication
(10) Pub. No.: US 2011/0316269 A1
(43) Pub. Date: Dec. 29, 2011

(54) SECURITY ELEMENT

(75) Inventor: Matthias Müller, Bechtsrieth (DE)

(73) Assignee: HUECK FOLIEN GES. M.B.H., Baumgartenberg (AT)

(21) Appl. No.: 13/002,368

(22) PCT Filed: Jul. 6, 2009
(86) PCT No.: PCT/EP2009/004864

§ 371 Date: Apr. 5, 2011

(30) Foreign Application Priority Data
Aug. 25, 2008 (EP) 08014968.5

(51) Int. Cl. B42D 15/00

(52) U.S. Cl. 283/85

(57) ABSTRACT

The invention relates to a security element comprising a transparent carrier substrate and a color-changing element made of a layer reflecting electromagnetic waves, a spacing layer, and a layer in the form of metal clusters, characterized in that the layer reflecting the electromagnetic waves is applied to the transparent carrier substrate partially as a line raster and partially as a contiguous layer made of one or more different metals.

The invention relates to a security element which can be verified without any auxiliary means.

WO 2004/014663 A discloses a method for producing forgery-proof identification features consisting in each case of at least one layer which reflects electromagnetic waves, a spacer layer and a layer formed by metallic clusters, wherein a partial or full-area layer which reflects electromagnetic waves, and subsequently one or more partial and/or full-area polymeric layers of defined thickness are applied on a carrier substrate, and a layer which is formed by metallic clusters and is produced using a vacuum-technological method or from solvent-based systems is applied onto the spacer layer.

The identification feature exhibits, depending on the viewing angle, different colors or color effects.

It was an object of the invention to provide a security element which can at all times be verified simply and reliably by untrained persons without any technical auxiliary means, but which nevertheless ensures very high protection against forgeries.

The subject matter of the invention is therefore a security element, having a transparent carrier substrate and a color-changing element, consisting of a layer which reflects electromagnetic waves, a spacer layer and a layer formed by metallic clusters, characterized in that the layer which reflects electromagnetic waves is formed on the transparent carrier substrate at least partially as a line raster and partially as a full-area layer comprising one or more different metals.

Possible carrier substrates are for example flexible transparent plastics films, for example made from PI, PP, OPP, PE, PPS, PEEK, PEK, PEI, PAEK, LCP, PEN, PBT, PET, PA, PC, COC, POM, ABS, PVC, PTFE, fluoropolymers such as Teflon, PVB etc.

The carrier films preferably have a thickness of 5-700 μm, preferably 5-200 μm, particularly preferably 5-50 μm.

The color-changing element is preferably an element that is produced according to WO 2004/014663 A and consists of a layer which reflects electromagnetic waves, a spacer layer and a metallic cluster layer.

The layer which reflects electromagnetic waves can preferably consist of metals, such as aluminum, gold, chromium, silver, copper, tin, platinum, nickel, palladium, titanium, and the alloys thereof, such as nickel/chromium, copper/aluminum and the like. The layer which reflects electromagnetic waves is applied at least partially in the form of a line raster, for example in the form of letters, characters, guilloches, patterns, symbols and the like, with the metalization having a translucent appearance in this region.

This layer can in this region consist of one or different metal(s).

The raster has approximately 40-200, preferably 60-120, particularly preferably 70-90, l/cm.

In the regions which are not covered by the line raster, the metalization is applied over the full area and is thus opaque.

The regions which are metalized over the full area and the regions which are metalized in a line raster or in the form of letters, characters, guilloches, patterns, symbols and the like can consist of the same metal or of in each case two or more different metals.

The layer which reflects electromagnetic waves can in particular regions be applied in the form of the line raster and in the other regions over the full area using known methods, such as spraying, vapor deposition, sputtering, printing (gravure, flexographic, screen, digital printing), lacquering, roller application methods, or metalization followed by demetalization methods and the like.

The subsequent polymeric layer or layers can likewise be applied over the full area or partially. The polymeric layers consist for example of paint or lacquer systems based on nitrocellulose, epoxy, polyester, rosin, acrylate, alkyde, melamine, PVA, PVC, isocyanate or urethane systems.

This polymeric layer serves substantially as a transparent spacer layer.

The polymeric layer can be applied by any coating method, for example by way of spreading, lacquering, pouring, spraying, printing (screen printing, gravure printing, flexographic printing or digital printing methods) or roller application methods.

A layer formed by metallic clusters is subsequently applied onto the polymeric layer. The metallic clusters can consist for example of aluminum, gold, palladium, platinum, chromium, silver, copper, nickel and the like or of the alloys thereof, such as Au/Pd or Cr/Ni. This cluster layer can be applied by way of sputtering (for example ion beam or magnetron) or vapor deposition (electron beam or thermal) from a solution or by way of adsorption.

When viewed under incident light, a characteristic color change is formed, depending on the viewing angle, in those regions that, over their full area, are positioned over the full area of the layer which reflects electromagnetic waves.

In the regions where the layer which reflects electromagnetic waves is in the form of a raster, the color change can also be seen.

In transmitted light, however, it is possible to see a contrast in this region, and the patterns, raster, letters, characters, symbols and the like become visible.

Thereby a security element is provided, which can be verified simply, quickly and reliably even by untrained persons under any lighting conditions.

Owing to the complexity of the layered structure, the security element is at the same time almost impossible to forge.

In one special embodiment, a diffractive layer, which can preferably be embossed into a radiation-curable lacquer, can furthermore be present on the carrier substrate.

The radiation-curable lacquer can for example be a radiation-curable lacquer system on the basis of a polyester system, an epoxy system or polyurethane system containing two or more different photoinitiators known to the person skilled in the art, which can at different wavelengths initiate curing of the lacquer system to various extents.

For example, one photoinitiator may be activatable at a wavelength of 200 to 400 nm, and the second photoinitiator in that case at a wavelength of 370 to 600 nm. There should be sufficient difference between the activation wavelengths of the two photoinitiators so that the second photoinitiator is not excited too strongly while the first photoinitiator is activated. The range at which the second photoinitiator is excited should be in the transmission wavelength range of the carrier substrate used. For the main curing operation (activation of the second photoinitiator), electron radiation may also be used.

A water-soluble lacquer can also be used as the radiation-curable lacquer. Polyester-based lacquer systems are preferred.

The surface structure is molded into the radiation-curable lacquer layer for example at controlled temperature using a die or using an embossing mold, said lacquer layer having been pre-cured up to the gel point by means of activation of the first photoinitiator and being in this state at the time of molding.

If a water-soluble radiation-curable lacquer is used, pre-drying, for example by means of IR emitters, can be carried out beforehand, if appropriate.

The security element according to the invention can therefore, if appropriate, be used, after appropriate finishing processes (for example to form threads, bands, strips, patches or other formats) as a security feature in data carriers, especially valuable documents such as passports, tickets, banknotes or labels, seals and the like, but also in packaging materials for sensitive goods such as pharmaceuticals, cosmetics, data carriers, electronic devices and the like.

The security element according to the invention can in this case be at least partially embedded in the valuable document or the packaging, or applied thereon. In one embodiment, the security element can also bridge a cutout in the substrate (valuable document or packaging) or be applied in register with a transparent region in the substrate.

1. A security element, having a transparent carrier substrate and a color-changing element, consisting of a layer which reflects electromagnetic waves, a spacer layer and a layer formed by metallic clusters, characterized in that the layer which reflects electromagnetic waves is formed on the transparent carrier substrate at least partially as a line raster and partially as a full-area layer comprising one or more different metals.

2. The security element as claimed in claim 1, characterized in that the layer which reflects electromagnetic waves and is in the form of a line raster is designed in the form of letters, characters, guilloches, patterns, symbols and has a translucent appearance.

3. The security element as claimed in claim 1, characterized in that the security element additionally has an optically active structure.

4. The security element as claimed in claim 1, characterized in that the line raster has 200-400 l/cm.

5. Use of the security element as claimed in claim 1 for at least partial embedding in a valuable document or a packaging.

6. Use of the security element as claimed in claim 1 for at least partial embedding in a valuable document or a packaging, wherein the embedding is effected in register with a region of the valuable document or the packaging.

7. Use of the security element as claimed in claim 1 for application onto a valuable document or a packaging, wherein the application is effected in register with a region of the valuable document or the packaging.

8. Use of the security element as claimed in claim 1 for bridging a cutout in a valuable document or a packaging.

9. The security element as claimed in claim 2, characterized in that the line raster has 200-400 l/cm.

10. Use of the security element as claimed in claim 2 for at least partial embedding in a valuable document or a packaging.

11. Use of the security element as claimed in claim 3 for at least partial embedding in a valuable document or a packaging.

12. Use of the security element as claimed in claim 4 for at least partial embedding in a valuable document or a packaging.

13. Use of the security element as claimed in claim 9 for at least partial embedding in a valuable document or a packaging.

14. Use of the security element as claimed in claim 2 for at least partial embedding in a valuable document or a packaging, wherein the embedding is effected in register with a region of the valuable document or the packaging.

15. Use of the security element as claimed in claim 3 for at least partial embedding in a valuable document or a packaging, wherein the embedding is effected in register with a region of the valuable document or the packaging.

16. Use of the security element as claimed in claim 4 for at least partial embedding in a valuable document or a packaging, wherein the embedding is effected in register with a region of the valuable document or the packaging.

17. Use of the security element as claimed in claim 9 for at least partial embedding in a valuable document or a packaging, wherein the embedding is effected in register with a region of the valuable document or the packaging.

18. Use of the security element as claimed in claim 2 for application onto a valuable document or a packaging, wherein the application is effected in register with a region of the valuable document or the packaging.

19. Use of the security element as claimed in claim 3 for application onto a valuable document or a packaging, wherein the application is effected in register with a region of the valuable document or the packaging.

20. Use of the security element as claimed in claim 4 for application onto a valuable document or a packaging, wherein the application is effected in register with a region of the valuable document or the packaging.
